(19) United States
(12) Patent Application Publication
(10) Pub. No.: US 2006/0032707 A1
(43) Pub. Date: Feb. 16, 2006

(54) Ladder stabilizer

(76) Inventor: Pasquale Sais, Hicksville, NY (US)

Correspondence Address: DONALD R. SCHOONOVER, 4211 ROLLING HILLS DRIVE, NIXA, MO, 65714-8771, US

(21) Appl. No.: 10/914,810

(22) Filed: Aug. 10, 2004

(51) Int. Cl. E06C 7/42

(52) U.S. Cl. 182/107

(57) ABSTRACT

A ladder, such as a ground-engaging ladder, is stabilized by a U-shaped, one-piece element that has spring-biased clamps on the distal ends of the short legs of the U-shaped body. The clamps engage an element of a building, such as a gutter, and the ladder is interposed between the U-shaped element and the gutter. The U-shaped element and the gutter surround the ladder to hold it in position.

### BACKGROUND OF THE INVENTION

1. Field of the Invention

The present invention relates to the general art of ladders, and to the particular field of safety devices for ground-supported ladders.

2. Discussion of the Related Art

Ladders are used for many purposes and in many situations. In some cases, the ladder may reach several stories and is used for time-consuming jobs. In nearly all situations, the ladder should be stable and supported in a stable manner.

One use of a ladder is for support while cleaning gutters. In this situation, the ladder is supported on the ground and leans against a building. In some cases, the ladder leans against the gutters during the cleaning process. Since the ladder may reach several stories, it is important for the ladder to be stable during use.

To this end, there are several inventions in the art that are intended to stabilize a ladder. For example, some ladders have extra legs or support structures that rest on the ground. While somewhat effective, these devices may be cumbersome to assemble and store. Still other devices are attached to the ladder and rest against a support structure. Again, these devices may be difficult to assemble and store and may not be versatile.

Therefore, there is a need for a device for stabilizing a ground-supported ladder that is easy to use and easy to store.

Some devices that are presently available are not easily positioned for use. The use and position of a ladder may be affected by the stabilizer. Thus, the ladder and the stabilizer are not as versatile as possible.

Therefore, there is a need for a device for stabilizing a ground-supported ladder that is versatile and does not interfere with the use or positioning of the ladder.

### PRINCIPAL OBJECTS OF THE INVENTION

It is a main object of the present invention to provide a device for stabilizing a ground-supported ladder that is easy to use and easy to store.

It is another object of the present invention to provide a device for stabilizing a ground-supported ladder that is versatile and does not interfere with the use or positioning of the ladder.

### SUMMARY OF THE INVENTION

These, and other, objects are achieved by a device for stabilizing a ground-supported ladder that includes a one-piece U-shaped body having two short legs connected together by a bight section. Each of the short legs includes a distal end spaced apart from the bight section. A spring-biased clamp on the distal end of each short leg. The clamps engage a gutter and a ladder is slipped between the gutter and the bight section of the device to be supported by the device.

Using the present invention will permit a ladder to be quickly and easily placed where it is most effective and then stabilized in position in a quick and easy manner. The ladder can be placed wherever it is most effective and the ladder-stabilizing device does not interfere with placement of the ladder. The ladder will be easily erected yet will be stable once in place. The ladder stabilizer embodying the present invention is most useful in stabilizing a ladder against a building gutter system.

### BRIEF DESCRIPTION OF THE DRAWING FIGURES

FIG. 1 is a perspective view of a ladder stabilizer embodying the present invention.

FIG. 2 is a side elevational view of a ladder being supported against a gutter of a building and stabilized by the ladder stabilizer embodying the present invention.

### DETAILED DESCRIPTION OF THE PREFERRED EMBODIMENT

Other objects, features and advantages of the invention will become apparent from a consideration of the following detailed description and the accompanying drawings.

Referring to the Figures, it can be understood that the present invention is embodied in a gutter 10 of a building 12 and a one-piece U-shaped body 14.

Body 14 includes a bight section 16 with first and second ends 18 and 20 respectively. Body 14 further includes a first short leg 22 having a proximal end 24, which is one-piece with first end 18 of the bight section 16, and a distal end 26, which is spaced apart from proximal end 24. A second short leg 30 has a proximal end 32, which is one-piece with second end 20 of the bight section 16, and a distal end 36, which is spaced apart from proximal end 32 of the second short leg 30 and is also spaced apart from distal end 26 of the first short leg 22.

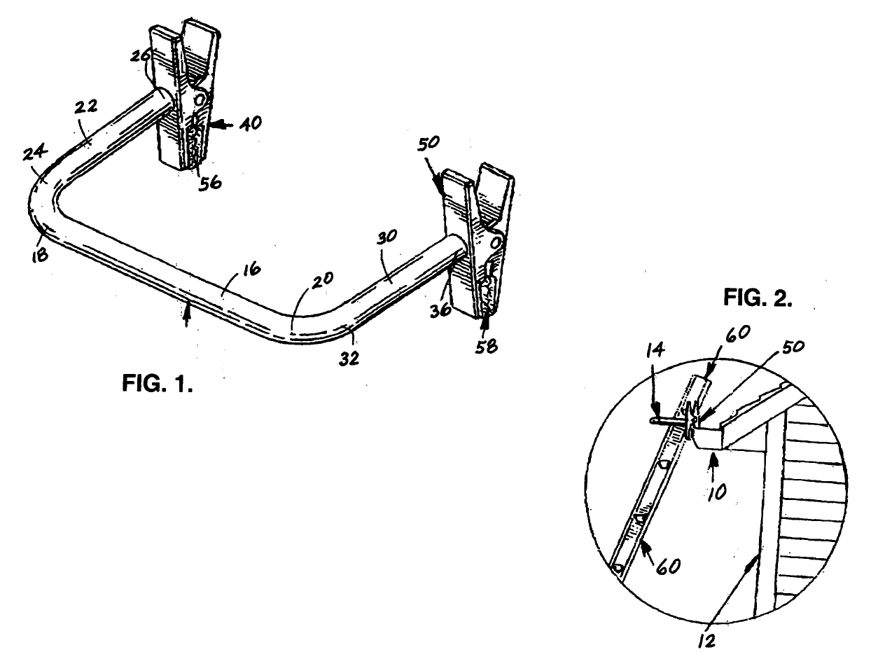

A first spring-biased clamp 40 is one-piece with distal end 26 of first short leg 22. First spring-biased clamp 40 is biased toward a closed condition shown in FIG. 1. First spring-biased clamp 40 is adapted to engage gutter 10 in the set up condition shown in FIG. 2. A second spring-biased clamp 50 is one-piece with distal end 36 of second short leg 30. Second spring-biased clamp 50 is biased toward the closed condition as shown in FIG. 1. Second spring-biased clamp 50 is adapted to engage gutter 10 in the set up condition shown in FIG. 2. Each of the clamps 40, 50 includes a jaw, such as jaws 52 and 54, and each jaw includes a rubber layer, such as layers 56 and 58 on the jaws. The rubber layers 56, 58 prevent damage to the gutter 10 when the clamps 40, 50 are attached to the gutter 10.

The one-piece nature of clamp 50 makes that clamp very strong and reliable when in use as shown in FIG. 2.

A ladder 60 is slidingly interposed between one-piece U-shaped body 14 and gutter 10 in the set-up condition shown in FIG. 2. Ladder 60 is in sliding abutting contact with gutter 10 with one-piece U-shaped body 14 and gutter 10 surrounding ladder 60 to hold the ladder 60 against the gutter 10 and to prevent the ladder 60 from moving away from the gutter 10.

Use of the device embodying the present invention can be understood by those skilled in the art based on the teaching of this disclosure. A ladder 60 is positioned adjacent to the building and the ladder 60 is leaned against the gutter 10 at the selected location. A user then ascends the ladder 60 and wraps body 14 around the ladder 60 and clamps the body 14 to the gutter 10. The ladder 60 will be held in position while the user works from the ladder 60. Once a task is completed, the body 14 is removed from the gutter 10 by loosening the clamps 40, 50 and the body 14 is removed from around the ladder 60. The person carries the body 14 with him as he descends the ladder 60. The ladder can then be moved as desired.

It is understood that while certain forms of the present invention have been illustrated and described herein, it is not to be limited to the specific forms or arrangements of parts described and shown.

What is needed and desired to be covered by Letters Patent is as follows:

1. A ladder stabilizer comprising:
(a) a one-piece U-shaped body having
(1) a bight section with first and second ends,
(2) a first short leg having a proximal end one-piece with the first end of the bight section and a distal end spaced apart from the proximal end of the first short leg, and
(3) a second short leg having a proximal end one-piece with the second end of the bight section and a distal end spaced apart from the proximal end of the second short leg and spaced apart from the distal end of the first short leg;
(b) a first spring-biased clamp which is one-piece with the distal end of the first short leg, said first spring-biased clamp being biased toward the closed condition;
(c) a second spring-biased clamp which is one-piece with the distal end of the second short leg, said second spring-biased clamp being biased toward the closed condition.

2. In combination:
(a) a gutter of a building; and
(b) a one-piece U-shaped body having
(1) a bight section with first and second ends,
(2) a first short leg having a proximal end one-piece with the first end of the bight section and a distal end spaced apart from the proximal end of the first short leg, and
(3) a second short leg having a proximal end one-piece with the second end of the bight section and a distal end spaced apart from the proximal end of the second short leg and spaced apart from the distal end of the first short leg;
(c) a first spring-biased clamp which is one-piece with the distal end of the first short leg, said first spring-biased clamp being biased toward the closed condition, said first spring-biased clamp being adapted to engage said gutter in the set up condition, said first spring-biased clamp including a jaw with a rubber layer on the jaw;
(d) a second spring-biased clamp which is one-piece with the distal end of the second short leg, said second spring-biased clamp being biased toward the closed condition, said second spring-biased clamp being adapted to engage said gutter in the set up condition, said second spring-biased clamp including a jaw with a rubber layer on the jaw; and
(e) a ladder slidingly interposed between said one-piece U-shaped body and said gutter, said ladder being in sliding abutting contact with said gutter with said one-piece U-shaped body and said gutter surrounding said ladder.
